(19) United States
(12) Patent Application Publication
(10) Pub. No.: US 2025/0277652 A1
(43) Pub. Date: Sep. 4, 2025

(54) EXTENDED FIRE MUX CONTROL WITH POLLING SOURCE

(71) Applicant: BAE Systems Information and Electronic Systems Integration Inc., Nashua, NH (US)

(72) Inventors: Alexander L. Lindsey, Bastrop, TX (US); Christopher E. Kohl, Austin, TX (US)

(73) Assignee: BAE Systems Information and Electronic Systems Integration Inc., Nashua, NH (US)

(21) Appl. No.: 18/591,228

(22) Filed: Feb. 29, 2024

(51) Int. Cl. F42B 5/15; B64D 7/00; F41A 19/68; F42B 4/26

(52) U.S. Cl. CPC F42B 5/15; B64D 7/00; F41A 19/68; F42B 4/26

(57) ABSTRACT

A countermeasure dispensing system (CMDS) that expands a legacy set of firing lines to a set of expanded firing lines and a set of polling lines. CMDS includes a sequencer, a breechplate that has a set of fire pins, an embedded fire select multiplexing (EFSM) assembly that is operatively connected with the breechplate and the sequencer. The EFSM assembly includes a set of firing lines that operatively connects with the sequencer and the set of fire pins of the breechplate, wherein at least one firing line is configurable for a desired state. The EFSM assembly also includes a set of polling lines that operatively connects with the sequencer and a control logic circuit (CLC) of the EFSM to configure the desired state for the at least one firing line.

### RELATED APPLICATIONS

Initially, it is noted that the present disclosure is related to the below listed U.S. patent applications (“the Incorporated Applications”), filed on equal date herewith, the entirety of each of which is incorporated herein as if fully rewritten. The Incorporated Applications are:
1. U.S. patent application Ser. No. ______, entitled “DUAL USE FIRE PIN FOR POWER AND COMMUNICATION”, having the Attorney Docket Number: 22-BAE-0262; and
2. U.S. patent application Ser. No. ______, entitled “DUAL USE MAGAZINE IDENTIFICATION WIRE WITH POWER ROUTING”, having the Attorney Docket Number: 22-BAE-0272.
   Since the present disclosure is related to the Incorporated Applications, some similar structural nomenclature is used herein when referencing some portions of the present disclosure relative to the Incorporated Applications. However, there may be some instances where structural nomenclature differs between similar elements and there may be other instances where nomenclature is similar between distinct elements relative to the present disclosure and the Incorporated Applications. Further, there may be instances in this disclosure that utilize similar reference numerals when referencing some portions or components of the present disclosure and its associated method(s) as in the Incorporated Applications. However, there may also be instances where (i) different reference numerals are utilized herein to refer to similar components as in the Incorporated Applications and/or (ii) similar reference numerals are utilized herein to refer to different components from the Incorporated Applications.

### TECHNICAL FIELD

The present disclosure relates generally to countermeasure dispensing systems.

### BACKGROUND ART

In current military technologies, military platforms, such as a military aircraft, typically include at least one countermeasure dispensing system (CMDS). The CMDS may eject one or more countermeasure expendables from the platform to dispense chaff material or flares away from the platform to counter a detected incoming threat, such as missiles or similar ballistic threats. Such dispensing of chaff material or flares away from the platform may then redirect the incoming threat away from the platform to reduce the amount of damage to the platform or to leave the platform unscathed and/or unharmed.

Each countermeasure dispenser in a standard CMDS is normally electrically connected to a countermeasure controller and/or sequencer unit for ejecting the countermeasure expendables from the dispenser; however, existing systems are limited to archaic and/or legacy dispensing systems that are difficult and/or costly to upgrade. For example, a standard countermeasure dispenser in a CMDS is limited to only carrying, for example, thirty expendables with a corresponding sequencer having thirty firing lines to dispense said expendables. Such limit of expendables and firing lines in the CMDS may create issues during military operation when many expendables must be dispensed from the CMDS in critical situations. The countermeasure dispenser and the sequencer in a CMDS also limits the capability of expanding the amount of expendables that may be provided on a military platform without removing and replacing the existing countermeasure dispenser and sequencer unit.

### SUMMARY OF THE INVENTION

The present disclosure addresses these and other issues by expanding fire lines between the countermeasure controller of a countermeasure system and the dispenser containing the countermeasure payloads therein. In one instance, the expansion of fire lines between the countermeasure controller of a countermeasure system and the dispenser containing the countermeasure payloads increases the number of payloads that may be loaded into a dispenser from thirty payloads up to forty-eight payloads. In another instance, the expansion of fire lines between the countermeasure controller of a countermeasure system and the dispenser containing the countermeasure payloads also creates a control circuit to monitor and control which banks of fire lines may be used at different time periods.

In one aspect, an exemplary embodiment of the present disclosure may provide a countermeasure dispensing system. The system includes a sequencer, a breechplate having a set of fire pins, and an embedded fire select multiplexing (EFSM) assembly operatively connected with the breechplate and the sequencer. The EFSM assembly includes a set of firing lines operatively connected with the sequencer and the set of fire pins of the breechplate, wherein at least one firing line is configurable for a desired state, and a set of polling lines operatively connected with the sequencer and a control logic circuit (CLC) of the EFSM to configure the desired state for the at least one firing line.

This exemplary embodiment or another exemplary embodiment may further include that the sequencer further comprises: a polling source; and a fire select multiplexer (mux) operatively connected with the polling source and the EFSM assembly. This exemplary embodiment or another exemplary embodiment may further include that the CLC comprises: a set of dividers operatively connected with the fire select mux by the set of polling lines; a set of comparators operatively connected with and in series with the set of dividers; and a latch integrated circuit operatively connected with the set of comparators by the set of polling lines. This exemplary embodiment or another exemplary embodiment may further include that the CLC further comprises: a set of first latch inputs of the latch integrated circuit operatively connected with a first group of dividers of the set of dividers, a first group of comparators of the set of comparators, and a set of first mux outputs of the fire select mux by a first group of polling lines of the set of polling lines; and a set of second latch inputs of the latch integrated circuit operatively connected with a second group of dividers of the set of dividers, a second group of comparators of the set of comparators, and a set of second mux outputs of the fire select mux by a second group of polling lines of the set of polling lines. This exemplary embodiment or another exemplary embodiment may further include that the CLC further comprises: a set of first bank lines operatively connecting a set of first latch outputs of the latch integrated circuit with a set of first inputs of a first switch of a set of switches; and a set of second bank lines operatively connecting the set of first latch outputs with a second set of inputs of the first switch of the set of switches. This exemplary embodiment or another exemplary embodiment may further include a first set of outputs of the first switch operatively connecting with a first group of firing lines of the set of firing lines; a second set of outputs of the first switch operatively connecting with a second group of firing lines of the set of firing lines. This exemplary embodiment or another exemplary embodiment may further include a first set of fire pins operatively connected with the first group of firing lines and is configurable between active states and deactivated states by the CLC and the first switch; and a second set of fire pins operatively connected with the second group of firing lines and is configurable between active states and deactivated states by the CLC and the first switch. This exemplary embodiment or another exemplary embodiment may further include that the CLC further comprises: a set of third bank lines operatively connecting a set of second latch outputs of the latch integrated circuit with a set of first inputs of a second switch of a set of switches; and a set of fourth bank lines operatively connecting the set of second latch outputs with a second set of inputs of the second switch of the set of switches. This exemplary embodiment or another exemplary embodiment may further include a first set of outputs of the second switch operatively connecting with a third group of firing lines of the set of firing lines; and a second set of outputs of the second switch operatively connecting with a fourth group of firing lines of the set of firing lines. This exemplary embodiment or another exemplary embodiment may further include a third set of fire pins operatively connected with the third group of firing lines and is configurable between active states and deactivated states by the CLC and the second switch; and a fourth set of fire pins operatively connected with the fourth group of firing lines and is configurable between active states and deactivated states by the CLC and the second switch.

In another aspect, an exemplary embodiment of the present disclosure may provide an embedded fire select multiplexing (EFSM) assembly operatively connected with a breechplate and a sequencer. The EFSM assembly includes a set of firing lines operatively connected with the sequencer and a set of fire pins of the breechplate, wherein the firing lines are configurable between an active state and a de-active state. The EFSM assembly also includes a set of polling lines operatively connected with the sequencer, a control logic circuit (CLC) operatively connected with the sequencer and the breechplate by the set of polling lines, and a set of switches operatively connected with the CLC and the set of fire pins of the breechplate.

This exemplary embodiment or another exemplary embodiment may further include that the CLC comprises: a set of dividers operatively connected with a fire select mux of the sequencer by the set of polling lines; a set of comparators operatively connected with and in series with the set of dividers; and a latch integrated circuit operatively connected with the set of comparators and the set of switches by the set of polling lines. This exemplary embodiment or another exemplary embodiment may further include that the set of switches comprises: a first switch operatively coupled with the CLC; a first group of fire pins of the set of fire pins; and a second group of fire pins of the set of fire pins; wherein the first switch is configured to set one of (i) first high bank lines of the first group of fire pins and (ii) first low bank lines of the first group of fire pins at the active state; and wherein the first switch is configured to set one of (i) second high bank lines of the second group of fire pins and (ii) second low bank lines of the second group of fire pins at the active state. This exemplary embodiment or another exemplary embodiment may further include that the set of switches comprises: a second switch operatively coupled with the CLC; a third group of fire pins of the set of fire pins; and a fourth group of fire pins of the set of fire pins; wherein the second switch is configured to set one of (i) third high bank lines of the third group of fire pins and (ii) third low bank lines of the third group of fire pins at the active state; and wherein the second switch is configured to set one of (i) fourth high bank lines of the fourth group of fire pins and (ii) fourth low bank lines of the fourth group of fire pins at the active state.

In yet another aspect, an exemplary embodiment of the present disclosure may provide a method. The method includes steps of providing a countermeasure dispensing system with a platform; the system comprises: a sequencer; a breechplate having a set of fire pins; and an embedded fire select multiplexing (EFSM) assembly operatively connected with the breechplate and the sequencer, the EFSM assembly comprises: a set of firing lines operatively connected with the sequencer and a set of fire pins of the breechplate; and a set of polling lines operatively connected with the sequencer and a control logic circuit (CLC) of the EFSM to configure desired states for the set of firing lines; effecting at least one polling pulse to be output from a polling source of the sequencer to a fire select multiplexer (mux); effecting the at least one polling pulse to be sent to the CLC by a first group of polling lines of the set of polling lines; effecting the CLC to be configured to a desired state such that a selected group of firing lines of the set of firing lines is provided in an active state; and effecting at least one firing pulse to be output from the sequencer to the selected group of firing lines of the set of firing lines.

This exemplary embodiment or another exemplary embodiment may further include that the step of effecting at least one polling pulse to be output from a polling source further comprises: effecting a first latch signal of the at least one polling pulse to be output from the polling source; and effecting a first pair of select signals of the at least one polling pulse to be output from the polling source. This exemplary embodiment or another exemplary embodiment may further include that the step of effecting the CLC to be configured to the desired state further comprises: effecting a first pair of select signals to be received by a first switch of a set of switches of the CLC; effecting the first switch to be configured to the desired state; effecting a first latch signal to be received by a latch integrated circuit of the CLC; and effecting the latch integrated circuit to hold the desired state of the first switch. This exemplary embodiment or another exemplary embodiment may further include effecting at least another polling pulse to be output from the polling source of the sequencer to the fire select mux; effecting the at least another polling pulse to be sent to the CLC by a second group of polling lines of the set of polling lines; and effecting the CLC to be configured to a desired state such that a second selected group of firing lines of the set of firing lines is provided in an active state. This exemplary embodiment or another exemplary embodiment may further include that the step of effecting at least another polling pulse to be output from the polling source further comprises: effecting a second latch signal of the at least another polling pulse to be output from the polling source; and effecting a second pair of select signals of the at least another polling pulse to be output from the polling source. This exemplary embodiment or another exemplary embodiment may further include that the step of effecting the CLC to be configured to the desired state further comprising: effecting the second pair of select signals to be received by a second switch of the set of switches of the CLC; effecting the second switch to be configured to the desired state; effecting the second latch signal to be received by the latch integrated circuit of the CLC; and effecting the latch integrated circuit to hold the desired state of the second switch.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1 (FIG. 1) is a diagrammatic view showing a platform having a countermeasure dispensing system (CMDS) wherein the CMDS is being used to deter an incoming enemy threat via countermeasure material.

FIG. 2 (FIG. 2) is a top front isometric perspective view of an exemplary CMDS according to one aspect of the present disclosure.

FIG. 3 (FIG. 3) is a top rear isometric perspective view of the CMDS of FIG. 2 according to one aspect of the present disclosure.

FIG. 4 (FIG. 4) is a close up exploded isometric perspective view of an exemplary embedded fire select multiplexing (EFSM) of the CMDS according to one aspect of the present disclosure.

FIG. 5 (FIG. 5) is a block diagrammatic view of an exemplary EFSM control circuit according to one aspect of the present disclosure.

FIG. 5A (FIG. 5A) is a partial block diagrammatic view of the exemplary EFSM control circuit according to one aspect of the present disclosure

FIG. 6 (FIG. 6) is another block diagrammatic view of the exemplary EFSM control circuit similar to FIG. 5, wherein an EFSM control logic circuit is shown according to one aspect of the present disclosure.

FIG. 7 (FIG. 7) is an exemplary method flowchart.

Similar numbers refer to similar parts throughout the drawings.

### DETAILED DESCRIPTION

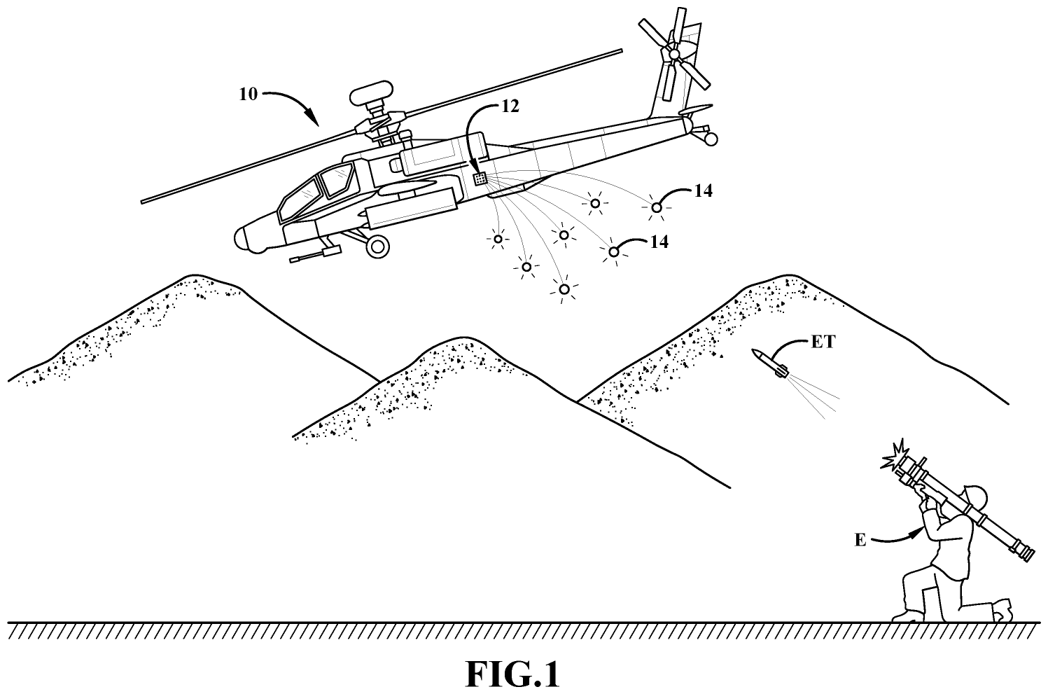

FIG. 1 illustrates a platform 10 which may be or include any ground vehicle, sea-based vehicle, aircraft, including manned and unmanned, and the like carrying a countermeasure dispensing system (CMDS) 12 thereon or therewith. According to one aspect, platform 10 may further be or include any remotely operated vehicles, drones, unmanned aerial vehicles (UAVs), and/or satellites. As used herein, platform 10 is illustrated as a manned aircraft (shown in FIG. 1 as a helicopter); however, the examples and description provided herein will be understood to be equally applicable across all versions of platform 10 as dictated by the desired implementation, unless specifically stated otherwise.

CMDS 12 may operably engage at least a portion of platform 10 and may be in operable communication therewith. According to one aspect, the CMDS 12 may be electrically connected to a legacy wiring harness A-kit (not illustrated) that is provided in the platform 10 to provide power and communication to some or all electrical components in the CMDS 12, which is described in more detail below.

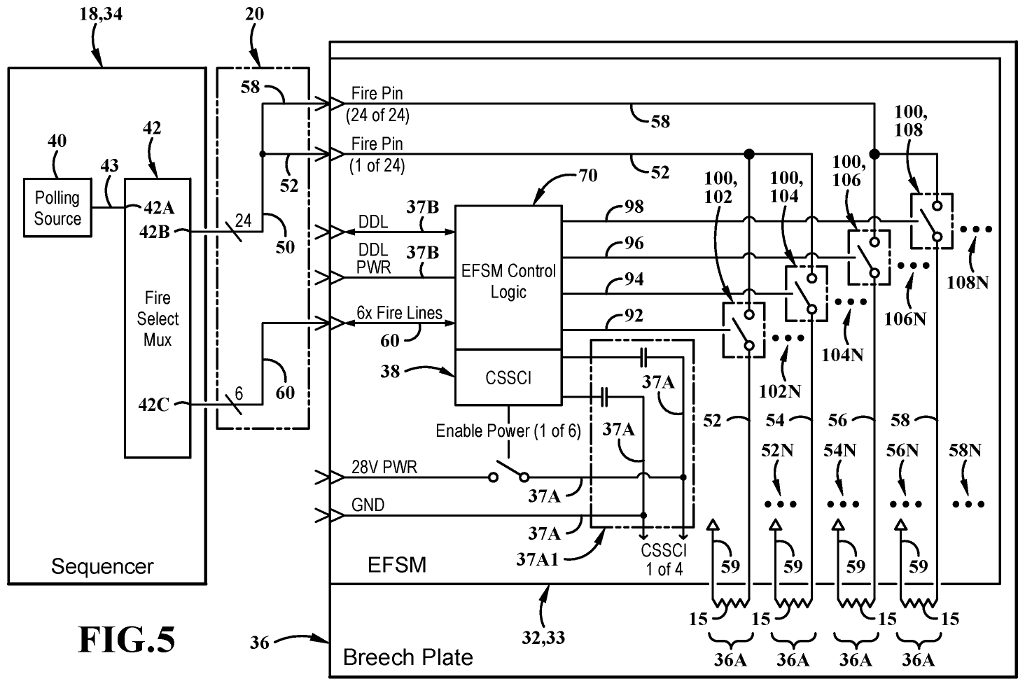

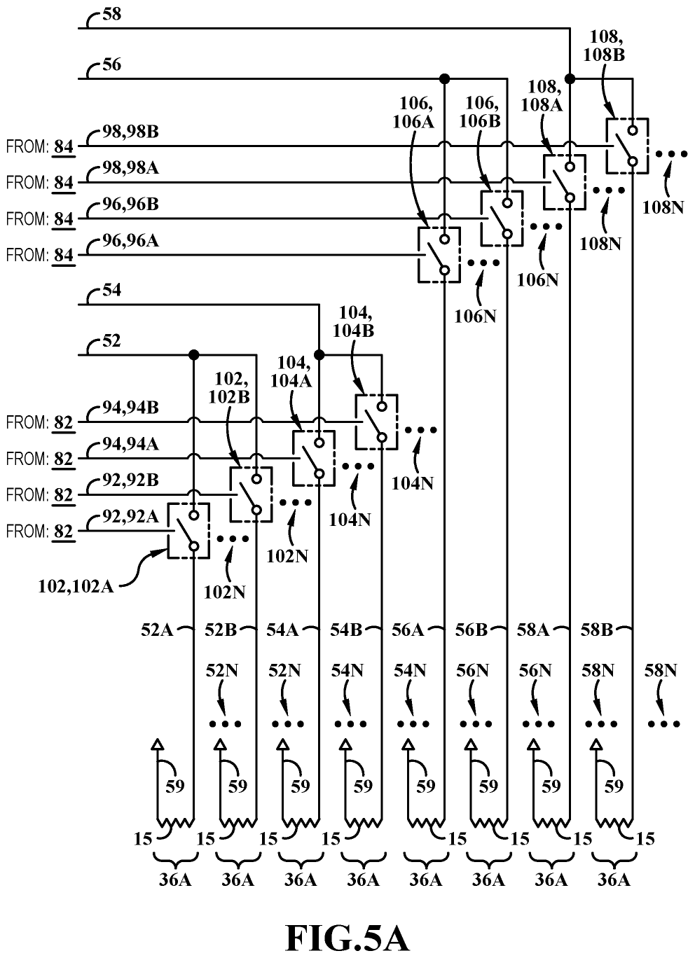

Prior to the initiation of a military operation or of a mission of the platform 10, the CMDS 12 may be loaded with a set of countermeasure expendables 14 which may be or include one or more of flares, chaff material, programmable decoys, or the like, for countermeasure purposes. In addition, each countermeasure expendable 14 of the set of countermeasure expendables 14 includes an impulse cartridge, such as a squib 15 (see FIGS. 5 and 5A), for detonating and dispensing the countermeasure material 14 from the platform 10. During military operation, the countermeasure material 14 (e.g., flare and/or chaff material) provides a distraction to an incoming enemy threat (shown as “ET” in FIG. 1), initiated by an enemy “E”, where the incoming enemy threat is diverted to the flare and/or chaff material countermeasure expendable 14 while allowing the platform 10 to remain relatively unscathed. During the military operation or the aerial mission, the platform 10 may receive a warning from an on-board electronic warfare (EW) system regarding the incoming enemy threat approaching the platform 10. Upon a determination made by the on-board EW system and/or an operator, the CMDS 12 may dispense a calculated amount of countermeasure expendables 14 from the set of countermeasure expendables 14 that are disposed with and carried by the platform 10.

As discussed further herein, it will be understood that the CMDS 12 is logically powered and controlled by at least one countermeasure controller (CMC) which may be or form a part of an on-board countermeasure system. This system may include suitable devices and apparatuses that are operably engaged with one another to logically control and power the CMDSs (such as CMDS 12) described and illustrated herein. In the illustrated embodiments, CMDSs described and illustrated herein may be logically powered and controlled by a legacy on-board components and/or systems retaining a majority of legacy devices and apparatuses that are operably engaged with and in communication with one another, unless explicitly stated otherwise. Examples of legacy devices and apparatuses that may be provided in this system include, but not limited to, a cockpit interface, discrete components, serial buses, a programmer, and data links. In another instance, a CMDS described and illustrated herein may be logically powered and controlled by a new on-board system having new devices and apparatuses that are operably engaged with one another.

Moreover, it will be understood that the on-board system may also retain and use legacy components of legacy CMDSs currently available. In one instance, a CMDS described and illustrated herein may maintain a legacy dispenser along with a legacy wiring harness A-kit operably engaging the CMDS with the legacy on-board system. In another instance, a CMDS described and illustrated herein may only maintain a legacy wiring harness operably engaging the CMDS with the legacy on-board system. Furthermore, it will be understood that CMDSs described and illustrated herein may also use new components that are not legacy to an aircraft nor a legacy on-board system provided on the aircraft. Such components of CMDS 12 are described in further details below.

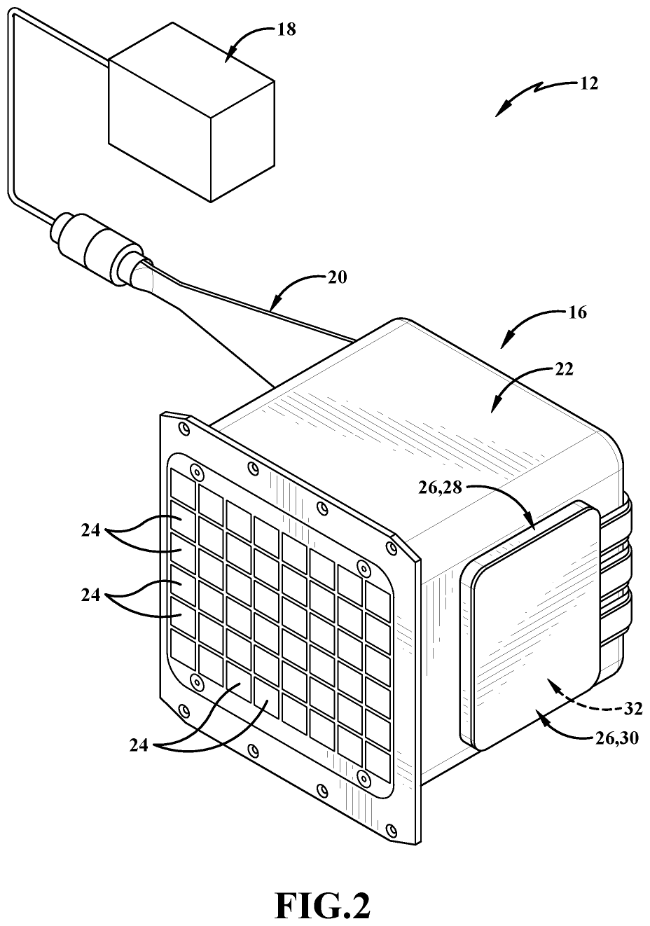

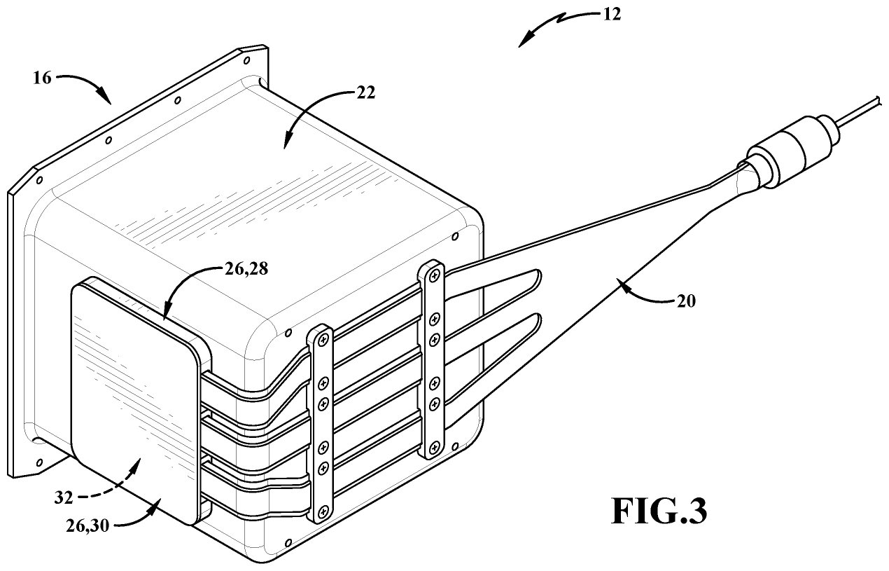

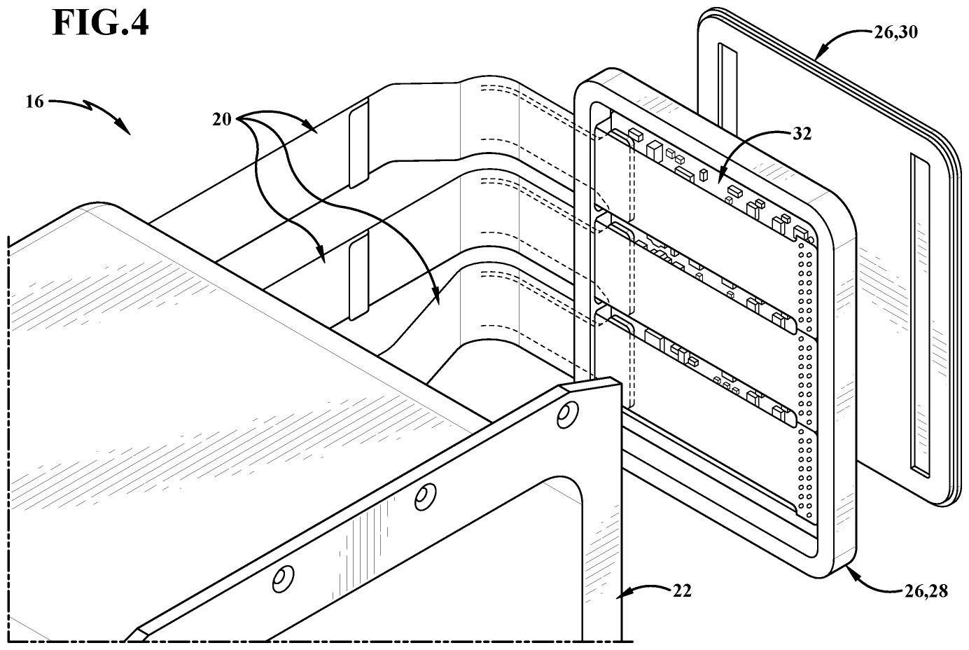

With reference to FIGS. 2-4, CMDS 12 may include a dispenser assembly 16 that operably engages with the platform 10. Dispenser assembly 16 may further include a countermeasure controller (CMC) 18, a wiring harness 20, a dispenser bucket 22, referred to simply as dispenser 22, a plurality of expendable canisters 24, which may include countermeasure expendables 14 contained therein, and an embedded fire select multiplexing (EFSM) assembly 26. Dispenser assembly 16 may be configured to hold various other assemblies, components, and parts of a CMDS 12 inside of the platform 10 for countermeasure operations, as described herein. Many of these components are not illustrated or described in detail herein; however, it will be understood that all necessary and usual components of an operable CMDS, such as CMDS 12, are included in the scope of the disclosure herein. Likewise, any necessary and usual connectors or fasteners may operably engage the dispenser assembly 16 and its components together and/or with the platform 10 through suitable and conventional means currently used in the art.

In one exemplary embodiment, dispenser assembly 16 may be a legacy AN/ALE-47 dispenser used in a standard AN/ALE-47 CMDS. In another exemplary embodiment, dispenser assembly 16 may be a new dispenser assembly that is configured to be used with a new CMDS currently available on platforms discussed herein.

CMC 18 may be any suitable standard countermeasure controller and may be integrated into other systems onboard the platform 10, including systems operable to detect and track incoming threats, location systems operable to detect and identify threats and enemies, pilot and operator interface systems, and the like. CMC 18 may include any suitable processors or processing components, logic controllers, or the like and may include legacy CMCs. As discussed below, CMC 18 may be operable to initiate the delivery of power and to transmit data signals to the EFSM assembly 26. CMC 18 may be automatically controlled through its connection and operable communication with other systems, or may be manually controlled by a pilot or operator of platform 10, as desired. According to one non-limiting example, CMC 18 may be automatically controlled by a threat detection system onboard an aircraft to deploy one or more expendables 14 in response to the detection of an incoming threat. Alternatively, in a similar scenario, the threat detection system may alert the pilot of the aircraft, who may then decide to direct the CMC 18 to deploy one or more expendables 14 in response to the threat.

Dispenser assembly 16 may also include wiring harness 20 which may be configured to provide an electrical connection between the dispenser 22 and the CMC 18 provided on the platform 10 to enable power and data communication between the dispenser 22 and the CMC 18 for dispensing and/or ejecting expendables 14 from the CMDS 12, as described further below. Wiring harness 20 may provide electrical and data connections between the vehicle's 10 existing wiring system, such as a legacy A-kit or the like in an aircraft, and the CMDS 12. Such connections included in the wiring harness are discussed in greater detail below.

Dispenser bucket 22, at its most basic, may be a housing for a plurality of expendable canisters 24 which may hold and ultimately deploy the countermeasure expendables 14 as described herein. It should be understood that dispenser 22 may include any necessary and usual components, including mounting surfaces, hardware, and the like. As mentioned above, dispenser 22 may be a legacy dispenser that may be modified to accommodate the EFSM assembly 26 (discussed below) or may alternatively be a new dispenser configured to replace previous dispensers in other CMDSs. It is contemplated that dispenser 22 (and dispenser assembly 16 by extension) may be configured to “plug and play” in existing CMDSs utilizing existing wiring A-kit harnesses and other existing wiring from the platform 10 in which the dispenser assembly 16 and dispenser 22 are installed. By only replacing and/or modifying the dispenser 22 as described herein may allow retrofitting of older legacy systems with minimal modification and minimal cost. Further, the use of such legacy assets may allow interchangeability between existing CMDSs and the present CMDS 12 which may further reduce costs and maintenance requirements.

Referring to EFSM assembly 26, EFSM assembly 26 is operable as the interface between the CMC 18 and the dispenser assembly 16, as discussed in more detail below. EFSM assembly 26 may include a housing 28 and cover 30, which may further encase an EFSM card circuitry assembly (CCA) 32 that includes a detection control circuit 33. The EFSM CCA 32 (referred to further herein as simply CCA 32) may be a printed circuit board and/or printed circuit assembly encompassing both power and data multiplexing circuits, as discussed below. The inclusion of the CCA 32 and its components may allow for the dual use fire pins for both power and communications, as well as the dual use fire pin wires for power delivery to the expendable payloads 14 of the CMDS 12. It is the presence and operation of these dual use fire pins and dual use fire pin wires that provide the benefit of increased power delivery up to 20 W and increased data transmission rates up to 500 k baud, as discussed further below.

CMC 18 may further be or include a sequencer, such as sequencer 34, and a power source, such as a 28V power control module (PCM) (not illustrated herein). Sequencer 34 may be in direct connection with dispenser 22. Specifically, CMC 18 may be in direct connection with EFSM assembly 26 of dispenser 22 and operable with the control circuit 32 of CCA 32, which is discussed in further below.

Dispenser assembly 16 may further include a breechplate 36 that operably engages with the dispenser 22, and may be housed inside of the dispenser 22. Breechplate 36 may include and provide any suitable number of firing lines as needed to connect the EFSM assembly 26, or more particularly the CCA 32, to a set of fire pins 36A in operable connection with the expendable canisters 24. The set of fire pin mechanisms (not shown) may be any suitable fire pin mechanisms that are capable of initiating impulse cartridges (such as squibs) to dispense countermeasure material from countermeasure expendables known in the art. In one exemplary embodiment, a set of fire pin mechanisms that may be used include fire pin mechanisms described and illustrated in U.S. patent application Ser. No. 17/345,551. In another exemplary embodiment, a set of fire pin mechanisms that may be used include fire pin mechanisms described and illustrated in U.S. patent application Ser. No. 18/045,194. While the breechplate 36 is shown diagrammatically, the breechplate 36 will be understood to further house any suitable electrical connections and/or electrical wiring that operably engages with each fire pin mechanism of the set of fire pin mechanisms to the CCA 32.

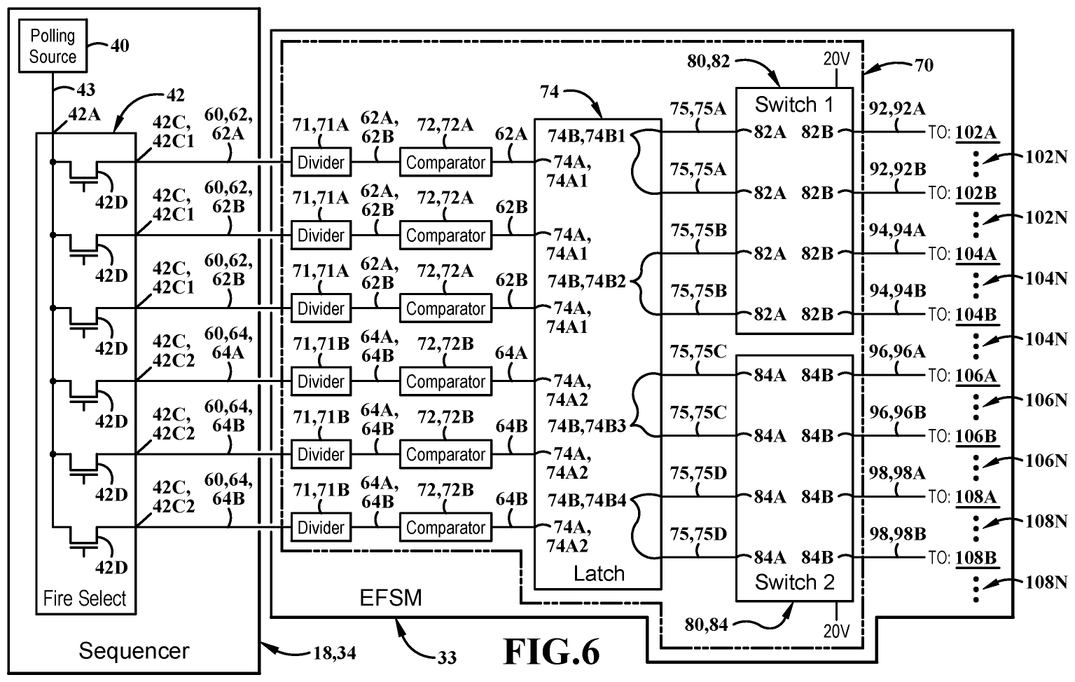

With reference to FIGS. 5 and 6, an exemplary detection control circuit 33 of CCA 32 is shown and will be described in more detail. In particular, FIGS. 5 and 6 illustrate a block diagram of the detection control circuit 33 of CCA 32 and the sequencer 34. Unless specifically called out or stated otherwise, the components of CCA 32 may be standard components. For example, as a printed card assembly, CCA 32 may include standard connectors, including power connectors, grounds and the like, along with other standard components such as capacitors, transistors, voltage gates, etc. Such components may be standard in that they may be unmodified from their normal construction and may be used according to their normal operation.

The CCA 32 may include both a power interface 37A and communication interface 37B allowing the CMC 18 to control and communicate with a payload over the same fire pin pairs 36A of breechplate 36. This interface may be a countermeasure smart stores communication interface 38, known as CSSCI 38, which may further allow both a high power and fast baud rate between the countermeasure controller and payload allowing power ratings of up to 20 watts with a 500 k baud rate. This interface, particularly the power interface 37A, may be power delivered over serial communication standard (denoted by dash lines labeled 37A1), such as RS-485 ON-OFF KEYED. Prior systems utilizing dedicated power and communications systems could only achieve approximately 100 milliwatts of power with a maximum of 115.2 k baud rate on data communications between the countermeasure controller and the payload of the dispenser.

The CSSCI power and communications interface allows the use of a multiplexing and modulation scheme to prevent degradation of a data signal while simultaneously keeping the power component below a sure fire level of a squib 15 utilized to launch one or more countermeasure expendables 14 from the dispenser 22 and canisters 24. In doing so, the modulation of data may utilize a sine wave band pass signal in order to prevent data signal degradation while the power component may maintain the modulation utilizing direct current with a low band pass signal.

Accordingly, the utilization of the same path for both power and data may allow the CMC 18 to pre-power or prime the expendable countermeasure system payloads (e.g. the expendables 14) while within the magazine of the dispenser 22 which may allow the expendable 14 to utilize a lower complexity initiator such as a squib 15 while simultaneously allowing any smart payload components to have mission data files updated on the fly and in real time to adapt to specific threat environments. This may enable the use of the present systems in current countermeasure scenarios while further enabling future electronic warfare system parameters to be fed to countermeasure payloads in real time. Providing a highly adaptable countermeasure the may be more effective in wider and more technologically advanced situations.

With respect to sequencer 34, sequencer 34 may also have additional components and devices for controlling firing lines and polling lines of detection control circuit 33. As best seen in FIGS. 5-6, sequencer 34 includes a polling source 40 that is configured to send one or more electrical pulses to CCA 32 that assists in configuring and/or setting the detection control circuit 33 to a desired state. In particular, polling source 40 is configured to send one or more electrical pulses to CCA 32 that includes a polling or latch signal and a pair of select signals that assists in configuring and/or setting the detection control circuit 33 to a desired state; such electrical pulse that includes a polling or latch signal and a pair of select signals is discussed in greater detail below. It should be understood that polling source 40 is a conventional and/or commercially available current generator that outputs an electrical pulse at a desired rate or time period and at a desired amperage that assists in configuring and/or setting the detection control circuit 33 to a desired state. In one exemplary embodiment, polling source 40 may output an electrical pulse of about 150 mA at 50 μs to assist in configuring and/or setting the detection control circuit 33 to a desired state

Sequencer 34 may also include a fire select multiplexer 42 (hereinafter fire select mux 42). As best seen in FIGS. 5-6, the fire select mux 42 includes an input 42A, a set of first or firing outputs 42B that operatively connects with the detection control circuit 33, and a set of second or polling outputs 42C that operatively connects with the detection control circuit 33. In the present disclosure, the polling source 40 and the fire select mux 42 operatively connect with one another by an electrical connection 43 which connects with the input 42A of fire select mux 42. The fire select mux 42 also includes a set of switches or gates 42D that connect with the input 42A, the set of firing outputs 42B, and the set of polling outputs 42C. In operation, the polling source 40 may send at least one electrical pulse to the fire select mux 42 by the electrical connection 43 in which the at least one electrical pulse may be directed to a specific firing line or polling line by the set of switches 42D, which is discussed in further detail below.

CMDS 12 also includes a set of firing lines 50 that operatively connects the EFSM 26 and the sequencer 34 with one another. As best seen in FIGS. 5-5A, the set of firing lines 50 operatively connects the set of firing outputs 42B with the detection control circuit 33 to send one or more firing signals to the EFSM 26 and the breechplate 36 for ejecting one or more countermeasure expandables 14 from the platform 10.

In the present disclosure, the fire select mux 42, and components and devices of the detection control circuit 33, expand the legacy number of firing lines of the set of firing lines 50 from thirty firing lines to forty-eight firing lines while only using twenty-four of the legacy thirty firing lines; the remaining six firing lines of the legacy thirty fire lines are discussed in greater detail below. With such expansion, and as best seen in FIG. 6, the set of firing lines 50 includes a first group of firing lines 52, a second group of firing lines 54, a third group of firing lines 56, and a fourth group of firing lines 58. With respect to the first group of firing lines 52, the first group of firing lines 52 includes a first or high side bank firing lines 52A and a second or low side bank firing lines 52B (see FIG. 6). Similarly, the second group of firing lines 54 also includes high side bank firing lines 54A and low side bank firing lines 54B, the third group of firing lines 56 includes high side bank firing lines 56A and low side bank firing lines 56B, and the fourth group of firing lines 58 includes high side bank firing lines 58A and low side bank firing lines 58B.

With this configuration, each firing line of the first group of firing lines 52 is operatively connected to a pair of fire pins 36A of the breechplate 36 where one fire pin of the pair of fire pins 36A is connected with a high bank fire line from the high side bank firing lines 52A, and the other fire pin of the pair of fire pins 36A is connected with a low bank fire line from the low side bank firing lines 52B. In operation, one of the high side bank firing lines 52A or the low side bank firing lines 52B is set to an active or firing state, by the detection control circuit 33, while the other bank of firing lines 52A, 52B remains in a deactivated or cease state, by the detection control circuit 33; such setting of active and deactivated states by the detection control circuit 33 is discussed in greater detail below. Such configuration also applies equally to the second group of firing lines 54, the third group of firing lines 56, and the fourth group of firing lines 58.

Still referring to the set of firing lines 50, the first group of firing lines 52 includes a finite number of high bank firing lines 52A and low bank firing lines 52B. For brevity, such remaining high bank firing lines 52A and low bank firing lines 52B of the first group of firing lines 52 are denoted by an ellipse symbol labeled 52N. Similarly, each of the second, third, and fourth groups of firing lines 54, 56, 58 includes a finite number of high bank fire lines 54A, 56A, 58A and low bank fire lines 54B, 56B, 58B. For brevity, such remaining high bank fire lines 54A, 56A, 58A and low bank fire lines 54B, 56B, 58B of each of the second, third, and fourth groups of firing lines 54, 56, 58 are denoted by ellipse symbols labeled 54N, 56N, 58N respectively.

As stated previously, the total number of firing lines in the set of firing lines 50 has been expanded from the legacy thirty fire lines to forty-eight fire lines to house and eject more countermeasure expandables 14 from platform 10. As such, the high side bank firing lines 52A of the first group of firing lines 52 includes six high side bank firing lines, and the low side bank firing lines 52B of the first group of firing lines 52 also includes six low side bank firing lines; as such, the ellipse symbol labeled 52N signifies the remaining five high side bank firing lines 52A and the remaining low side bank firing lines 52B not illustrated herein for brevity. With such arrangement, the first group of firing lines 52 includes twelve fire lines out of the forty-eight fire lines. Similarly, the high side bank firing lines 54A, 56A, 58A of each of the second, third, and fourth groups of firing lines 54, 56, 58 of the set of firing lines 50 includes six high side bank firing lines, and the low side bank firing lines 54B, 56C, 58C of each of the second, third, and fourth groups of firing lines 54, 56, 58 of the set of firing lines 50 includes six low side bank firing lines; as such, the ellipse symbols labeled 54N, 56N, 58N signify the remaining five high side bank firing lines 54A, 56A, 58A and the remaining low side bank firing lines 54B, 56B, 58B not illustrated herein for brevity. With such arrangement, the second, third, and fourth groups of firing lines 54, 56, 58 include the remaining thirty-six fire lines out of the forty-eight fire lines.

Still referring to the set of firing lines 50, the high side bank firing lines 52A, 54A, 56A, 58A of the first, second, third, and fourth groups of firing lines 52, 54, 56, 58 of the set of firing lines 50 also includes a set of return lines 59. As best seen in FIGS. 5 and 6A, the set of return lines 59 is operatively connected with the EFSM 26 and a corresponding squib 15. In operation, each return line of the set of return lines 59 provides information between the EFSM 26 and the corresponding squib 15 prior to ignition of the squib 15 and ignition of the squib 15. Such set of return lines 59 is also included with the low side bank firing lines 52B, 54B, 56B, 58B of the first, second, third, and fourth groups of firing lines 52, 54, 56, 58 of the set of firing lines 50.

CMDS 12 also includes a set of polling lines 60 that operatively connects the EFSM 26 and the sequencer 34 with one another. As best seen in FIGS. 5 and 6, the set of polling lines 60 operatively connects the set of polling outputs 42C with the detection control circuit 33 to send one or more polling signals to the EFSM 26 and the breechplate 36 for configuring and/or setting the set of firing lines 50 between active states or deactivated states; such components that configure and/or set the set of firing lines 50 between active states or deactivated states are discussed in greater detail below.

In the present disclosure, the six remaining fire lines of the legacy thirty fire lines are designated and used as the set of polling lines 60. As best seen in FIG. 6, the set of polling lines 60 includes a first group of polling lines 62 that operatively connects with a first group of polling outputs 42C1 of the set of polling outputs 42C of the fire select mux 42. As best seen in FIG. 6, the first group of polling lines 62 includes a first latch or poll line 62A and a first pair of select lines 62B; such use of the first latch line 62A and the first pair of select lines 62B is discussed in further detail below. Similarly, the set of polling lines 60 also includes a second group of polling lines 64 that operatively connects with a second group of polling outputs 42C2 of the set of polling outputs 42C of the fire select mux 42. As best seen in FIG. 6, the second group of polling lines 64 includes a second latch or poll line 64A and a second pair of select lines 64B; such use of the second latch line 64A and the second pair of select lines 64B is discussed in further detail below.

EFSM 26 also includes a control logic circuit (CLC) 70. As best seen in FIGS. 5 and 6, CLC 70 operatively connects with the sequencer 34 by the set of polling lines 60. CLC 70 is configured to set and/or channel either high side bank firing lines 52A, 54A, 56A, 58A or low side bank firing lines 52B, 54B, 56B, 58B of one or more groups of firing lines 52, 54, 56,58 of the set of firing lines 50 to active states or deactivated states. Such components of CLC 70 are discussed in greater detail below.

CLC 70 includes a set of resistive dividers or voltage dividers 71 (hereinafter “dividers”) and a set of comparators 72. As best seen in FIG. 6, each divider of the set of dividers 71 and each comparator of the set of comparators 72 operatively connects with the sequencer 34, particularly with the fire select mux 42, by the set of polling lines 60. In the present disclosure, a first group of dividers 71A of the set of dividers 71 and a first group of comparators 72A of the set of comparators 72 operatively connect with the fire select mux 42 by the set of polling lines 60. In particular, the first group of dividers 71A and the first group of comparators 72A of the operatively connect with the first group of polling outputs 42C1 of the set of polling outputs 42C of the fire select mux 42 and with the first group of polling lines 62 of the set of polling lines 60. The set of dividers 71 and the set of comparators 72 also includes a second group of dividers 71B and a second group of comparators 72B that operatively connect with the fire select mux 42 by the set of polling lines 60. In particular, the second group of dividers 71B and the second group of comparators 72B operatively connect with the second group of polling outputs 42C2 of the set of polling outputs 42C of the fire select mux 42 and with the second group of polling lines 64 of the set of polling lines 60.

In operation, each divider of the set of dividers 71 is configured to receive an electrical pulse from the polling source 40 at a desired current amperage (e.g., approximately 150 mA at 50 μsec). Once received, each divider of the set of dividers 71 is configured to output an electrical pulse at a voltage that is proportional to the current amperage of the electrical pulse. In one example, each divider of the set of dividers 71 may include a first resistor device that is configured at a first resistive load and a second resistive device that is configured at a second resistive load that is greater than the first resistive load. Upon such output of the electrical signal from the divider 71, the comparator 72 that is in series with the respective divider 71 is tripped and is configured to send a logic signal to a transparent latch integrated circuit of detection circuit 33. In one example, the logic signal outputted from the comparator 72 may be a 3.3V CMOS logic signal for configuring the transparent latch integrated circuit, which is discussed in greater detail below.

Based on the combination of the set of dividers 71 and the set of comparators 72, this combination acts as a conversion circuit or system that is configured to convert the current signal of the electrical pulse to a logic signal for circuit logic functionality. While such combination is discussed herein, any other suitable configuration may be used to convert the current signal of the electrical pulse to a logic signal for circuit logic functionality In one exemplary embodiment, CLC 70 may include transistor-transistor logic circuitry to convert the current signal of the electrical pulse to a logic signal for circuit logic functionality.

CLC 70 also includes a transparent latch integrated circuit (hereinafter “latch”) generally referred to as 74. As best seen in FIG. 6, latch 74 operatively connects with the set of dividers 71 and the set of comparators 72 and is downstream of the fire select mux 42 and the polling source 40 of the sequencer 34. Still referring to FIG. 6, latch 74 includes a set of latch inputs 74A that has a first group of latch inputs 74A1 and a second group of latch inputs 74A2. In the present disclosure, the first group of latch inputs 74A1 operatively connects with the first group of dividers 71A and the first group of comparators 72A by the first group of polling lines 62, and the second group of latch inputs 74A2 operatively connects with the second group of dividers 71B and the second group of comparators 72B by the second group of polling lines 64.

Still referring to FIG. 6, latch 74 includes a set of latch outputs 74B that operatively connects with a set of bank lines 75. As best seen in FIG. 6, a first group of latch outputs 74B1 of the set of latch outputs 74B operatively connects with a first group of bank lines 75A of the set of bank lines 75. Similarly, a second group of latch outputs 74B2 of the set of latch outputs 74B operatively connects with a second group of bank lines 75B of the set of bank lines 75, a third group of latch outputs 74B3 of the set of latch outputs 74B operatively connects with a third group of bank lines 75C of the set of bank lines 75, and a fourth group of latch outputs 74B4 of the set of latch outputs 74B operatively connects with a fourth group of bank lines 75D of the set of bank lines 75. Such use and operation of the set of latch outputs 74B and the set of bank lines 75 are discussed in greater detail below.

Still referring to latch 74, latch 74 is also operatively connected with the CCA 32. With such connection between the CCA 32 and the latch 74, latch 74 is configured to capture and set the states of the set of firing lines 50 between high bank firing lines (e.g., high bank firing lines 52A, 54A, 56A, 58A) and low bank firing lines (e.g., high bank firing lines 52B, 54B, 56B, 58B). In one instance, the latch 74 sets a number of firing lines of the set of firing lines 50 at a high bank state (e.g., high bank firing lines 52A, 54A, 56A, 58A) based on capturing the configuration of the fire select mux 42 (i.e., the states of the sets of gates 42D) that sends a first electrical pulse at a first voltage outputted by the polling source 40. In another instance, the latch 74 sets a number of firing lines of the set of firing lines 50 at a low bank state (e.g., low bank firing lines 52B, 54B, 56B, 58B) based on the configuration of the fire select mux 42 (i.e., the states of the sets of gates 42D) that sends a second electrical pulse at a second voltage outputted by the polling source 40. Such operation of configuring the latch 74 is discussed in greater detail below.

Detection control circuit 33 also includes a set of switches 80. As best seen in FIG. 6, the set of switches 80 includes a first switch 82 that includes a set of inputs 82A and a set of outputs 82B. In the present disclosure, the first switch 82 operatively connects with the latch 74 by the set of bank lines 75. In particular, the set of inputs 82A of the first switch 82 operatively connects with the first group of latch outputs 74B1 of the set of latch outputs 74B, by the first group of bank lines 75A, and with the second group of latch outputs 74B2 of the set of latch outputs 74B, by the second group of bank lines 75B. With such connections, the latch 74 may transmit the pair of select signals included in the electrical pulse that is outputted from the polling source 40; such use and operation of the first switch 82 upon receiving the electrical pulse from the polling source 40 is discussed in greater detail below.

Still referring to the first switch 82, the set of outputs 82B of the first switch 82 operatively connects with a set of output bank lines 90. As best seen in FIG. 6, a first group of outputs of the set of outputs 82B operatively connects with a first group of output bank lines 92 of the set of output bank lines 90 in which the first group of output bank lines 92 includes a first or high side bank switch lines 92A and a second or low side bank switch lines 92B. Similarly, a second group of outputs of the set of outputs 82B operatively connects with a second group of output bank lines 94 of the set of output bank lines 90 in which the second group of output bank lines 94 includes a first or high side bank switch lines 94A and a second or low side bank switch lines 94B. Such use and operation of the set of outputs 82B of the first switch 82, the first group of output bank lines 92, and the second group of output bank lines 94 are discussed in greater detail below.

The set of switches 80 includes a second switch 84 that includes a set of inputs 84A and a set of outputs 84B. In the present disclosure, the second switch 84 operatively connects with the latch 74 by the set of bank lines 75. In particular, the set of inputs 84A of the second switch 84 operatively connects with the third group of latch outputs 74B3 of the set of latch outputs 74B, by the third group of bank lines 75C, and with the fourth group of latch outputs 74B4 of the set of latch outputs 74B, by the fourth group of bank lines 75D. With such connections, the latch 74 may transmit the pair of select signals included in a second electrical pulse that is outputted from the polling source 40; such use and operation of the second switch 84 upon receiving the second electrical pulse from the polling source 40 is discussed in greater detail below.

Still referring to the second switch 84, the set of outputs 84B of the second switch 84 operatively connects with the set of output bank lines 90. As best seen in FIG. 6, a first group of outputs of the set of outputs 84B operatively connects with a third group of output bank lines 96 of the set of output bank lines 90 in which the third group of output bank lines 96 includes a first or high side bank switch lines 96A and a second or low side bank switch lines 96B. Similarly, a second group of outputs of the set of outputs 84B operatively connects with a fourth group of output bank lines 98 of the set of output bank lines 90 in which the fourth group of output bank lines 98 includes a first or high side bank switch lines 98A and a second or low side bank switch lines 98B. Such use and operation of the set of outputs 84B of the second switch 84, the third group of output bank lines 96, and the fourth group of output bank lines 98 are discussed in greater detail below.

Detection control circuit 33 also includes a set of field-effect transistors (hereinafter “FETs”). As best seen in FIG. 6, the set of FETs 100 includes a first group of FETs 102 that operatively connects with the first switch 82 by the first group of output bank lines 92. In particular, first or high side bank FETs 102A of the first group of FETs 102 operatively connects with the first switch 82, by the high side bank switch lines 92A, and second or low side bank FETs 102B of the first group of FETs 102 operatively connects with the first switch 82, by the low side bank switch lines 92B. Similarly, the set of FETs 100 also includes a second group of FETs 104 that operatively connects with the first switch 82 by the second group of output bank lines 94. In particular, first or high side bank FETs 104A of the second group of FETs 104 operatively connects with the first switch 82, by the high side bank switch lines 94A, and a second or low side bank FETs 104B of the second group of FETs 104 operatively connects with the first switch 82, by the low side bank switch lines 94B. With such connections, the first switch 82 may allow electrical pulses to pass to the first group of FETs 102 and the second group of FETs 104 to activate high side bank firing lines 52A, 54A of the set of firing lines 50 or low side bank firing line 52B, 54B of the set of firing lines 50 based on the latch and bank select pulses received upstream.

As best seen in FIG. 6, the set of FETs 100 also includes a third group of FETs 106 that operatively connects with the second switch 84 by the third group of output bank lines 96. In particular, first or high side bank FETs 106A of the third group of FETs 106 operatively connects with the second switch 84, by the high side bank switch lines 96A, and second low side bank FETs 106B of the third group of FETs 106 operatively connects with the second switch 84, by the low side bank switch lines 96B. Similarly, the set of FETs 100 also includes a fourth group of FETs 108 that operatively connects with the second switch 84 by the fourth group of output bank lines 98. In particular, first or high side bank FETs 108A of the fourth group of FETs 108 operatively connects with the second switch 84, by the high side bank switch lines 98A, and second or low side bank FETs 108B of the fourth group of FETs 108 operatively connects with the second switch 84, by the low side bank switch lines 98B. With such connections, the second switch 84 may allow electrical pulses to pass to the third group of FETs 108 and the fourth group of FETs 108 to activate high side bank firing line 56A, 58A of the set of firing lines 50 or low side bank firing line 56B, 58B of the set of firing lines 50 based on the latch and bank select pulses received upstream.

Still referring to the set of FETs 100, the first group of FETs 102 includes a finite number of high side bank FETs 102A and low side bank FETs 102B. For brevity, such remaining high side bank FETs 102A and low side bank FETs 102B of the first group of FETs 102 are each denoted by an ellipse symbol labeled 102N. Similarly, each of the second, third, and fourth groups of FETs 104, 106, 108 includes a finite number of high side bank FETs 104A, 106A, 108A and low side bank FETs 104B, 106B, 108B. For brevity, such remaining high side bank FETs 104A, 106A, 108A and low side bank FETs 104B, 106B, 108B for each of the second, third, and fourth groups of FETs 104, 106, 108 are denoted by ellipse symbols labeled 104N, 106N, 108N respectively.

With this new configuration, the total number of FETs of the set of FETS 100 is double the total number of firing lines in the set of firing lines 50 due to having pairs of high bank fire lines 52A, 54A, 56A, 56B and low bank fire lines 52B, 54B, 56B, 58B. As such, the high side bank FETs 102A of the first group of FETs 102 includes six high side bank FETs, and the low side bank FETs 102B of the first group of FETs 102 includes six low side bank FETs; as such, the ellipse symbols labeled 102N signify the remaining five high side bank FETs 102A and the remaining low side bank FETs 102B not illustrated herein for brevity. With such arrangement, the first group of FETs 102 includes twelve FETs out of the forty-eight FETs. Similarly, the high side bank FETs 104A, 106A, 108A of each of the second, third, and fourth groups of FETs 104, 106, 108 of the set of FETs 100 includes six high side bank FETs, and the low side bank FETs 104B, 106B, 108B of each of the second, third, and fourth groups of FETs 104, 106, 108 of the set of FETs 100 includes six low side bank FETs; as such, the ellipse symbols labeled 104N, 106N, 108N signify the remaining five high side bank FETs 104N, 106N, 108N and the remaining low side bank FETs 104N, 106N, 108N not illustrated herein for brevity. With such arrangement, the second, third, and fourth groups of FETS 104, 106, 108 include the remaining thirty-six FETs out of the forty-eight FETs.

In operation, the electrical pulse outputted by the polling source 40 provides two actions to the latch 74, the set of switches 80, and the set of FETs 100. First, the pair of select signals included in the electrical pulse sets and/or configures the first switch 82 or the second switch 84 (depending on which group of polling lines 60 received the electrical pulse as channeled by the fire select mux 42) to a desired state where the selected switch 80, 82 pulses a signal to the connected group of FETs 102, 104, 106, 108 to activate high side bank firing lines or low side bank firing lines of the group of firing lines operatively connected with the group of FETs 102, 104, 106, 108. If the fire select mux 42 selects the first group of polling lines 62, a first select signal of the pair of select signals included in the electrical pulse configures the first group of FETs 102 to a desired state where the first switch 82 pulses a signal to the first group of FETs 102 to activate either the high side bank firing lines 52A or the low side bank firing lines 52B of the first group of firing lines 52 based on the first select signal. Additionally, a second select signal of the pair of select signals included in the electrical pulse configures the second group of FETs 104 to another desired state where the second group of FETs 104 activates either the high side bank firing lines 54A or the low side bank firing lines 54B of the second group of firing lines 54. Such operation applies equally to the second switch 84 when the fire select mux 42 selects the second group of polling lines 64 to send another electrical pulse outputted by the polling source 40 to configure a desired state of the third group of fire lines 56 and the fourth group of fire lines 58 via the third group of FETs 106 and the fourth group of FETs 108.

Second, the latch 74 is also configured to set and hold electrical states of the first switch 82 of the detection control circuit 33 and the second switch 84 of the detection control circuit 33 based on an electrical pulse outputted by the polling source 40. In one instance, the latch 74 is configured to set and hold electrical states of the first switch 82 of the detection control circuit 33 upon receiving a first latch signal included in the electrical pulse that is outputted by the polling source 40 and channeled by the fire select mux 42. In another instance, the latch 74 is also configured to set and hold electrical states of the second switch 84 of the detection control circuit 33 upon receiving a second latch signal included in a second electrical pulse that is outputted by the polling source 40 and channeled by the fire select mux 42.

It should be understood that each switch of the set of switches 80 may be any suitable switch or gating mechanism that configures the set of FETs 100 to desired states for activing or deactivating the set of firing lines 50 during countermeasure operations. In one exemplary embodiment, each switch of the set of switches 80 is an analog switch that configures the set of FETs 100 to desired states for activating or deactivating the set of firing lines 50 during countermeasure operations. In this exemplary embodiment, each switch of the set of switches 80 is also powered by a power supply or source (at least 20V) to drive and/or operate the set of FETs 100.

It should also be understood that set of FETs 100 discussed herein may be any suitable FET that is suitable for activing or deactivating the set of firing lines 50 in response to receiving electrical pulses and/or signals from the set of switches 80. In one exemplary embodiment, each FET of the set of FETs 100 may be a metal-oxide semiconductor FET (or nFET or MOSFET) suitable for activing or deactivating the set of firing lines 50 in response to receiving electrical pulses and/or signals from the set of switches 80.

Having now described the components and devices provided in CMDS 12, a method of using CMDS with detection control circuit 33 is now discussed in greater detail below.

Once CMDS 12 in in operation (either the platform 10 is grounded or in flight), the sequencer 34 may output and/or transmit at least one electrical pulse to the EFSM 26 to configure and set the detection control circuit 33 and the fire select mux 42 to desired states. Initially, the polling source 40 outputs a first electrical pulse to the input 42A of the fire select mux 42 via the electrical connection 43. As discussed previously, the first electrical pulse includes a first latch signal and a first pair of select signals for configuring the detection control circuit 33 of the EFSM 26. Upon receiving the electrical pulse, the fire select mux 42 may then actuate the set of gates 42D to a first position where the set of gates 42D channels the first electrical pulse along the first group of polling lines 62 of the set of polling lines 60. Particularly, the first latch signal of the first electrical pulse is transmitted along the first latch line 62A of the first group of polling lines 62, and the first pair of select signals of the first electrical pulse is transmitted along the first pair of select lines 62B of the first group of polling lines 62.

Once the first electrical pulse is transmitted and channeled from the fire select mux 42, the first electrical pulse is received by the first group of dividers 71A of the set of dividers 71 and the first group of comparators 72A of the set of comparators 72. At this stage, each respective divider of the first group of dividers 71A and each respective comparator of the first group of comparators 72A convert the current signal of the electrical pulse to a logic signal for circuit logic functionality. Once converted, the pulse is then outputted and sent to the latch 74. Particularly, the pulse is received at the first group of latch inputs 74A1 of the set of latch inputs 74A of the latch 74.

Upon receiving the pulse from the first group of dividers 71A and the first group of comparators 72A, the latch 74 utilizes both the first latch signal and the first pair of select signals of the first electrical pulse to set the first switch 82 to a desired state. In one instance, a first select signal of the first pair of select signals included in the electrical pulse may configure the first switch 82 at a first state where one of the high side bank firing lines 52A and the low side bank firing lines 52B of the first group of firing lines 52 is provided in an active state (i.e., a fire signal is received from the sequencer 34) by the first group of FETs 102, and the other high side bank firing lines 52A or the low side bank firing lines 52B of the first group of firing lines 52 is provided in a deactivated state (i.e., a fire signal is not received from the sequencer 34) by the first group of FETs 102. In the same instance, a second select signal of the first pair of select signals included in the electrical pulse may configure the first switch 82 at the first state where one of the high side bank firing lines 54A and the low side bank firing lines 54B of the second group of firing lines 54 is provided in an active state (i.e., a fire signal is received from the sequencer 34) by the second group of FETs 104, and the other high side bank firing lines 54A and the low side bank firing lines 54B of the second group of firing lines 54 is provided in a deactivated state (i.e., a fire signal is not received from the sequencer 34) by the second group of FETs 104. Once the first switch 82 is provided at the first state to control the first and second groups of FETs 102, 104, the latch 74 maintains the first switch 82 at the first state upon receiving the first latch signal from the first electrical pulse. It should be noted that such first state maintained by the latch 74 is passed to the CCA 32 given the operative communication between the latch 74 and the CCA 32. It should also be noted that once the latch 74 is configured for this first state, the fire select mux 42 is also configured.

Subsequently, the polling source 40 outputs a second electrical pulse to the input 42A of the fire select mux 42 via the electrical connection 43. Similar to the first electrical pulse, the second electrical pulse also includes a second latch signal and a second pair of select signals for configuring the detection control circuit 33 of the EFSM 26. Upon receiving the electrical pulse, the fire select mux 42 may then actuate the set of gates 42D to a second position where the set of gates 42D channels the second electrical pulse along the second group of polling lines 64 of the set of polling lines 60. Particularly, the second latch signal of the second electrical pulse is transmitted along the second latch line 64A of the second group of polling lines 64, and the second pair of select signals of the second electrical pulse is transmitted along the second pair of select lines 64B of the first group of polling lines 64.

Once the second electrical pulse is transmitted and channeled from the fire select mux 42, the second electrical pulse is received by the second group of dividers 71B of the set of dividers 71 and the second group of comparators 72B of the set of comparators 72. At this stage, each respective divider of the second group of dividers 71B and each respective comparator of the second group of comparators 72B convert the current signal of the electrical pulse to a logic signal for circuit logic functionality. Once converted, the pulse is then outputted and sent to the latch 74. Particularly, the pulse is received at the second group of latch inputs 74A2 of the set of latch inputs 74A of the latch 74.

Upon receiving the pulse from the second group of dividers 71B and the second group of comparators 72B, the latch 74 utilizes both the second latch signal and the second pair of select signals of the second electrical pulse to set the second switch 84 to a desired state. In one instance, a first select signal of the second pair of select signals included in the second electrical pulse may configure the second switch 84 at a first state where one of the high side bank firing lines 56A and the low side bank firing lines 56B of the third group of firing lines 56 is provided in an active state (i.e., a fire signal is received from the sequencer 34) by the third group of FETs 106, and the other high side bank firing lines 56A and the low side bank firing lines 56B of the third group of firing lines 56 is provided in a deactivated state (i.e., a fire signal is not received from the sequencer 34) by the third group of FETs 106. In the same instance, a second select signal of the second pair of select signals included in the electrical pulse may configure the second switch 84 at the first state where one of the high side bank firing lines 58A and the low side bank firing lines 58B of the fourth group of firing lines 58 is provided in an active state (i.e., a fire signal is received from the sequencer 34) by the fourth group of FETs 108, and other high side bank firing lines 58A and the low side bank firing lines 58B of the fourth group of firing lines 58 is provided in a deactivated state (i.e., a fire signal is not received from the sequencer 34) by the fourth group of FETs 108. Once the second switch 84 is provided at the first state to control the third and fourth groups of FETs 106, 108, the latch 74 maintains the second switch 84 at the first state upon receiving the second latch signal from the first electrical pulse. It should be noted that such second state maintained by the latch 74 is also passed to the CCA 32 given the operative communication between the latch 74 and the CCA 32. It should also be noted that once the latch 74 is configured for this first state, the fire select mux 42 is also configured.

Once the set of switches 80 are configured, the sequencer 34 may then output firing pulses or signals along the set of firing lines 50 to the active fire pins 36A of the breechplate 36. In operation, the firing pulses will be channeled down selected firing lines 50 to selected fire pins 36A, via the fire select mux 42, for ejecting countermeasure payloads 14 from the platform 10. Particularly, the firing pulses are channeled down selected firing lines 50 to selected fire pins 36A based on configurations of each FET of the set of FETs 100 activated by the set of switches 80.

It should be understood that the latch 74 will maintain the state of the first switch 82 and the state of the second switch 84 until another electrical pulse that includes a different latch signal and a different pair of select signals changes the state of the latch 74. Such instances may arise when the remaining and/or unused countermeasure payloads 14 are still loaded in the dispenser 22 and certain firing lines of the set of firing lines 50 must be activated by the detection control circuit 33 to ejected said remaining and/or unused countermeasure payloads 14. In these instances, the same procedures mentioned above will be followed in order to change of the states of the latch 74 and the set of switches 80.

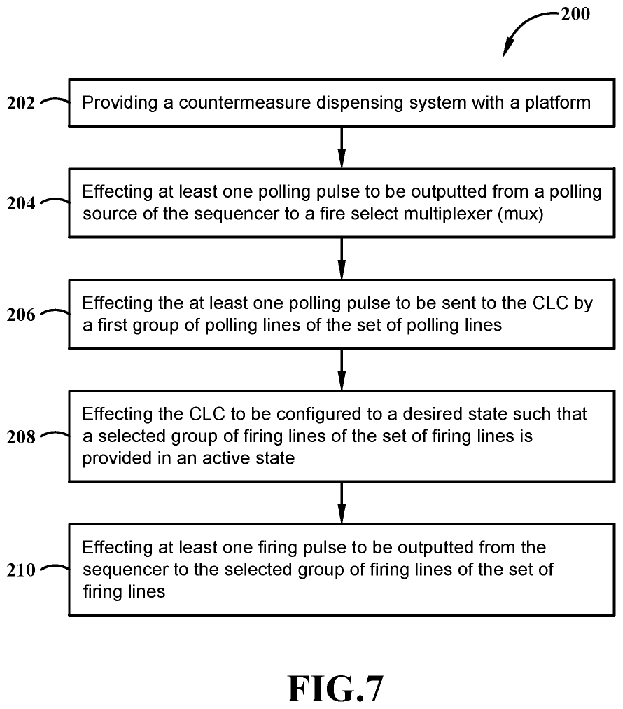

FIG. 7 illustrates a method 200. An initial step 202 of method 200 includes providing a countermeasure dispensing system with a platform; the system comprises: a sequencer; a breechplate having a set of fire pins; and an embedded fire select multiplexing (EFSM) assembly operatively connected with the breechplate and the sequencer, the EFSM assembly comprises: a set of firing lines operatively connected with the sequencer and a set of fire pins of the breechplate; and a set of polling lines operatively connected with the sequencer and a control logic circuit (CLC) of the EFSM to configure desired states for the set of firing lines. Another step 204 of method 200 includes effecting at least one polling pulse to be output from a polling source of the sequencer to a fire select multiplexer (mux). Another step 206 of method 200 includes effecting the at least one polling pulse to be sent to the CLC by a first group of polling lines of the set of polling lines. Another step 208 of method 200 includes effecting the CLC to be configured to a desired state such that a selected group of firing lines of the set of firing lines is provided in an active state. Another step 210 of method 200 includes effecting at least one firing pulse to be output from the sequencer to the selected group of firing lines of the set of firing lines.

In other exemplary embodiments, additional and/or optional steps may be further included with method 200. In one exemplary embodiment, method 200 may include that the step of effecting at least one polling pulse to be output from a polling source further comprises: effecting a first latch signal of the at least one polling pulse to be output from the polling source; and effecting a first pair of select signals of the at least one polling pulse to be output from the polling source. In another exemplary embodiment, method 200 may include that the step of effecting the CLC to be configured to the desired state further comprises: effecting the first pair of select signals to be received by a first switch of a set of switches of the CLC; effecting the first switch to be configured to the desired state; effecting the first latch signal to be received by a latch integrated circuit of the CLC; and effecting the latch integrated circuit to hold the desired state of the first switch. In another exemplary embodiment, method 200 may include steps of effecting at least another polling pulse to be output from the polling source of the sequencer to the fire select mux; effecting the at least another polling pulse to be sent to the CLC by a second group of polling lines of the set of polling lines; and effecting the CLC to be configured to a desired state such that a second selected group of firing lines of the set of firing lines is provided in an active state. In another exemplary embodiment, method 200 may include that the step of effecting at least another polling pulse to be output from the polling source further comprises: effecting a second latch signal of the at least another polling pulse to be output from the polling source; and effecting a second pair of select signals of the at least another polling pulse to be output from the polling source. In another exemplary embodiment, method 200 may include that the step of effecting the CLC to be configured to the desired state further comprising: effecting the second pair of select signals to be received by a second switch of the set of switches of the CLC; effecting the second switch to be configured to the desired state; effecting the second latch signal to be received by the latch integrated circuit of the CLC; and effecting the latch integrated circuit to hold the desired state of the second switch.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer or smartphone may be utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments. As such, one aspect or embodiment of the present disclosure may be a computer program product including least one non-transitory computer readable storage medium in operative communication with a processor, the storage medium having instructions stored thereon that, when executed by the processor, implement a method or process described herein, wherein the instructions comprise the steps to perform the method(s) or process(es) detailed herein.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software, and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

1. A countermeasure dispensing system comprising:
a sequencer;
a breechplate having a set of fire pins; and
an embedded fire select multiplexing (EFSM) assembly operatively connected with the breechplate and the sequencer, wherein the EFSM assembly comprises:
a set of firing lines operatively connected with the sequencer and the set of fire pins of the breechplate, wherein at least one firing line is configurable for a desired state; and
a set of polling lines operatively connected with the sequencer and a control logic circuit (CLC) of the EFSM to configure the desired state for the at least one firing line.

2. The countermeasure dispensing system of claim 1, wherein the sequencer further comprises:
a polling source; and
a fire select multiplexer (mux) operatively connected with the polling source and the EFSM assembly.

3. The countermeasure dispensing system of claim 2, wherein the CLC comprises:
a set of dividers operatively connected with the fire select mux by the set of polling lines;
a set of comparators operatively connected with and in series with the set of dividers; and
a latch integrated circuit operatively connected with the set of comparators by the set of polling lines.

4. The countermeasure dispensing system of claim 3, wherein the CLC further comprises:
a set of first latch inputs of the latch integrated circuit operatively connected with a first group of dividers of the set of dividers, a first group of comparators of the set of comparators, and a set of first mux outputs of the fire select mux by a first group of polling lines of the set of polling lines; and
a set of second latch inputs of the latch integrated circuit operatively connected with a second group of dividers of the set of dividers, a second group of comparators of the set of comparators, and a set of second mux outputs of the fire select mux by a second group of polling lines of the set of polling lines.

5. The countermeasure dispensing system of claim 4, wherein the CLC further comprises:
a set of first bank lines operatively connecting a set of first latch outputs of the latch integrated circuit with a set of first inputs of a first switch of a set of switches; and
a set of second bank lines operatively connecting the set of first latch outputs with a second set of inputs of the first switch of the set of switches.

6. The countermeasure dispensing system of claim 5, further comprising:
a first set of outputs of the first switch operatively connecting with a first group of firing lines of the set of firing lines;
a second set of outputs of the first switch operatively connecting with a second group of firing lines of the set of firing lines.

7. The countermeasure dispensing system of claim 6, further comprising:
a first set of fire pins operatively connected with the first group of firing lines and is configurable between active states and deactivated states by the CLC and the first switch; and
a second set of fire pins operatively connected with the second group of firing lines and is configurable between active states and deactivated states by the CLC and the first switch.

8. The countermeasure dispensing system of claim 5, wherein the CLC further comprises:
a set of third bank lines operatively connecting a set of second latch outputs of the latch integrated circuit with a set of first inputs of a second switch of a set of switches; and
a set of fourth bank lines operatively connecting the set of second latch outputs with a second set of inputs of the second switch of the set of switches.

9. The countermeasure dispensing system of claim 8, further comprising:
a first set of outputs of the second switch operatively connecting with a third group of firing lines of the set of firing lines; and
a second set of outputs of the second switch operatively connecting with a fourth group of firing lines of the set of firing lines.

10. The countermeasure dispensing system of claim 9, further comprising:
a third set of fire pins operatively connected with the third group of firing lines and is configurable between active states and deactivated states by the CLC and the second switch; and
a fourth set of fire pins operatively connected with the fourth group of firing lines and is configurable between active states and deactivated states by the CLC and the second switch.

11. An embedded fire select multiplexing (EFSM) assembly operatively connected with a breechplate and a sequencer the EFSM assembly comprises:
a set of firing lines operatively connected with the sequencer and a set of fire pins of the breechplate, wherein the firing lines are configurable between an active state and a deactivate state;
a set of polling lines operatively connected with the sequencer;
a control logic circuit (CLC) operatively connected with the sequencer and the breechplate by the set of polling lines; and
a set of switches operatively connected with the CLC and the set of fire pins of the breechplate.

12. The EFSM assembly of claim 11, wherein the CLC comprises:
a set of dividers operatively connected with a fire select mux of the sequencer by the set of polling lines;
a set of comparators operatively connected with and in series with the set of dividers; and
a latch integrated circuit operatively connected with the set of comparators and the set of switches by the set of polling lines.

13. The EFSM assembly of claim 11, wherein the set of switches comprises:
a first switch operatively coupled with the CLC;
a first group of fire pins of the set of fire pins; and
a second group of fire pins of the set of fire pins;
wherein the first switch is configured to set one of (i) first high bank lines of the first group of fire pins and (ii) first low bank lines of the first group of fire pins at the active state; and
wherein the first switch is configured to set one of (i) second high bank lines of the second group of fire pins and (ii) second low bank lines of the second group of fire pins at the active state.

14. The EFSM assembly of claim 13, wherein the set of switches comprises:
a second switch operatively coupled with the CLC;
a third group of fire pins of the set of fire pins; and
a fourth group of fire pins of the set of fire pins;
wherein the second switch is configured to set one of (i) third high bank lines of the third group of fire pins and (ii) third low bank lines of the third group of fire pins at the active state; and
wherein the second switch is configured to set one of (i) fourth high bank lines of the fourth group of fire pins and (ii) fourth low bank lines of the fourth group of fire pins at the active state.

15. A method, comprising:
providing a countermeasure dispensing system with a platform; the system comprises:
a sequencer;
a breechplate having a set of fire pins; and
an embedded fire select multiplexing (EFSM) assembly operatively connected with the breechplate and the sequencer, wherein the EFSM assembly comprises:
a set of firing lines operatively connected with the sequencer and a set of fire pins of the breechplate; and
a set of polling lines operatively connected with the sequencer and a control logic circuit (CLC) of the EFSM to configure desired states for the set of firing lines;
effecting at least one polling pulse to be output from a polling source of the sequencer to a fire select multiplexer (mux);
effecting the at least one polling pulse to be sent to the CLC by a first group of polling lines of the set of polling lines;
effecting the CLC to be configured to a desired state such that a selected group of firing lines of the set of firing lines is provided in an active state; and
effecting at least one firing pulse to be output from the sequencer to the selected group of firing lines of the set of firing lines.

16. The method of claim 15, wherein the step of effecting at least one polling pulse to be output from a polling source further comprises:
effecting a first latch signal of the at least one polling pulse to be output from the polling source; and
effecting a first pair of select signals of the at least one polling pulse to be output from the polling source.

17. The method of claim 15, wherein the step of effecting the CLC to be configured to the desired state further comprises:
effecting a first pair of select signals to be received by a first switch of a set of switches of the CLC;
effecting the first switch to be configured to the desired state;
effecting a first latch signal to be received by a latch integrated circuit of the CLC; and
effecting the latch integrated circuit to hold the desired state of the first switch.

18. The method of claim 15, further comprising:
effecting at least another polling pulse to be output from the polling source of the sequencer to the fire select mux;
effecting the at least another polling pulse to be sent to the CLC by a second group of polling lines of the set of polling lines; and
effecting the CLC to be configured to a desired state such that a second selected group of firing lines of the set of firing lines is provided in an active state.

19. The method of claim 16, wherein the step of effecting at least another polling pulse to be output from the polling source further comprises:
effecting a second latch signal of the at least another polling pulse to be output from the polling source; and
effecting a second pair of select signals of the at least another polling pulse to be output from the polling source.

20. The method of claim 19, wherein the step of effecting the CLC to be configured to the desired state further comprising:
effecting the second pair of select signals to be received by a second switch of the set of switches of the CLC;
effecting the second switch to be configured to the desired state;
effecting the second latch signal to be received by the latch integrated circuit of the CLC; and
effecting the latch integrated circuit to hold the desired state of the second switch.
